(19) United States
(12) Patent Application Publication
(10) Pub. No.: US 2014/0152227 A1
(43) Pub. Date: Jun. 5, 2014

(54) RELATIVISTIC PONDEROMOTIVE FORCE GENERATOR

(71) Applicant: ATIDRON LTD., Ramat Gan (IL)

(72) Inventors: Miron TUVAL, Ramat Gan (IL); Asher YAHALOM, Givaat Shmuel (IL)

(21) Appl. No.: 14/176,420

(22) Filed: Feb. 10, 2014

Related U.S. Application Data
(63) Continuation-in-part of application No. PCT/IL2013/050564, filed on Jul. 2, 2013.
(60) Provisional application No. 61/667,454, filed on Jul. 3, 2012.

(51) Int. Cl. H02K 1/06

(52) U.S. Cl. CPC H02K 1/06
USPC 318/503; 310/10

(57) ABSTRACT

A propulsion system is presented, the system comprising primary and secondary electromagnetic field generators being attached to a frame at a predetermined distance between them, and a control unit connected thereto and configured to create pulsating electromagnetic fields generated by at least one of the electromagnetic field generators. The pulsating electromagnetic field is configured to pulsate at time intervals determined in accordance with retardation time caused by said predetermined distance between the primary and secondary electromagnetic field generators. Interaction between the electromagnetic field generators and electromagnetic fields generated thereby provides a total net force acting on the system.

### RELATED APPLICATIONS

This is a Continuation-in-Part of Application No. PCT/IL2013/050564 filed Jul. 2, 2013, which claims the benefit of U.S. Provisional Application No. 61/667,454 filed Jul. 3, 2012. The disclosures of each of these prior applications are hereby incorporated by reference herein in their entirety.

### BACKGROUND AND TECHNOLOGICAL FIELD

The currently available, State-of-the-art propulsion means are symmetric open-systems whereby Newton's Third Law applies. Such propulsion-means rely either on the friction generated between two contacting surfaces (i.e. wheel rolling on road), or on substance expulsion for creating a directed momentum (i.e. rocket, propeller).

The present invention is in the field of propulsion systems and is particularly useful for closed-system propulsion motors in the sense that momentum is conserved in the total physical system containing both matter and field, but is not conserved in the matter part of the system.

### GENERAL DESCRIPTION

There is a need in the art for a novel propulsion system, capable of providing directional force within a closed material system. The present invention provides a closed-system propulsion utilizing retardation time for transmission of fields (e.g. electromagnetic fields), dictated by the theory of relativity, between at least two field generators.

This invention addresses a new kind of asymmetric closed-system propulsion that would exploit the time-delay τ, which, according to the principles of relativity, would be necessary for a primary electromagnetic field (henceforth Primary) generated at a given location to reach a secondary circuit (henceforth Secondary) located at a distance from said location. Thus, the system of the present invention utilizes at least primary and secondary electromagnetic field generators. The electromagnetic field generators are both mounted/attached to a rigid frame, located at a predetermined distance R between them. The system also comprises a control unit connectable to at least one of the electromagnetic field generators and configured to operate at least one generator to generate a pulsating electromagnetic field in accordance with the time delay τ associated with arrangement of the electromagnetic field generator.

The time lapse needed by an asymmetric field to achieve symmetry is here defined as “electromagnetic field-expanding time-delay τ”.

This invention teaches that the Primary develops an electromagnetic force Fₚ which does not impinge on the Primary when propagating recoil-free for a time τ until it reaches and interacts with the Secondary, when the conditions for enacting a reacting force of equal magnitude and opposed direction that will act on the Primary-Secondary system as postulated by Newton's Third Law are accomplished. More specifically, the electromagnetic force acting on the Primary electromagnetic field generator is not balanced by an equal and opposite force affecting the Secondary electromagnetic field generator, thereby providing total net force acting on the system.

The time-delay τ is an inverse function of the Primary electromagnetic-field propagation-speed, hereinafter τ propagation, which tends to equal the light velocity here denoted by the letter c. More specifically, the time-delay τ is indicative of the time required for information of variation in the electromagnetic field to travel the distance between the primary and secondary electromagnetic field generators.

During its τ propagation, the Primary's proprieties are ruled by the Principles of Relativity and are thus non-compatible with Newton's Third Law. In fact, any electromagnetic or magnetic field-generator is an asymmetric system for as long as its generated field has not reached a circuit in which an oppositely vectored field is induced. The same would apply to two or more expanding electromagnetic or magnetic fields that are asymmetric systems until they reach and interact with each other, whereby the condition of symmetry is achieved.

The scope of this invention rests on the well known phenomenology of electromagnetic asymmetric systems that do not abide by Newton's Third Law. It should be noted that the law of momentum conservation is maintained during operation of the system of the present invention, as the momentum gained by the material system is counter-balanced by an opposite momentum gained by the electromagnetic field. This provides that the total momentum of the entire physical system, which is composed of both matter and field, is conserved.

The electromagnetic field expanding time-delay would be exploitable at any distance R between the two coils so that:

$$\frac{R}{c} \neq 0$$

and is as large as possible. Generally, the larger the distance R, the longer the time-delay τ, allowing slower switching for operation of the system. It should however be noted that the strength of interaction and magnitude of the electromagnetic field decrease with the distance R between the electromagnetic field generators.

As described above, the propulsion system of the present invention may comprise at least primary and secondary electromagnetic field generators mounted at a predetermined distance between them on a frame, which is preferably rigid. The simplest way to create a practical application of this new concept would consist of using two conducting wire-loops disposed at a known distance from each other, whereby an electric time-independent current I₁(t)=Ī₁ caused in one of these loops designated as “primary coil” would electromagnetically interact with the other of these loops designated as “secondary coil” that would circulate a current configured so as to exploit the time delay inherent for completing an asymmetric unitary “Primary-Secondary” system. This invention teaches that by providing the “secondary coil” with a uniform second derivative current

$${I}_{2} ( t ) = 1 / 2 \overline{{I}_{2}} \frac{{t}^{2}}{{τ}_{c}^{2}}$$

calculated on that of the “primary coil” would make possible the creation of an asymmetric system of unreacted to forces, in contradiction to Newton's Third Law, so that a non-null resultant (F>0) will act during about the time span τ of pulsating current on the two-loops system. More specifically, the force acts as long as the current on the second loop can be described by the expression

$${I}_{2} ( t ) = 1 / 2 \overline{{I}_{2}} \frac{{t}^{2}}{{τ}_{c}^{2}} .$$

Thus, generally, a total force acts on the system as long as the electromagnetic field has a non-zero second derivative.

This invention would therefore consist of providing for an asymmetric system of forces being practically achieved by having a permanent primary current interacting with a secondary current created in a secondary coil by a pulsating, t-dependent current which has a non-zero second derivative.

Thus, according to one broad aspect of the present invention there is provided a propulsion system configured to operate as a closed-system, i.e. no material leaves the system other than electromagnetic fields. The system comprises at least primary and secondary electromagnetic field generators attached to a rigid frame, and a control unit connectable to at least one of the primary and secondary electromagnetic field generators. The control unit is configured and operable to cause at least one of the primary and secondary electromagnetic field generators to create pulsating electromagnetic fields at time intervals determined in accordance with time-delay for information transmission determined by said predetermined distance between the primary and secondary electromagnetic field generators, thereby providing a non-null force acting on the system. As indicated above, such time delay is determined by the time it takes for any variation on the field, created by one of the generators, to reach the other one. As known, electromagnetic fields propagate at the speed of light c (or generally in a medium c/n(ω)), and thus the time-delay may be determined as τ=R/c. Interaction between the pulsating electromagnetic field and the electromagnetic field generators thereby create a total net force acting on the system.

As indicated above, and for simplicity, it is assumed that the control unit operates to pulsate at least the secondary electromagnetic field generator. It should however be understood that the primary electromagnetic field generator may also be connected to the control unit and may also be pulsating to create varying electromagnetic fields. Thus, according to some embodiments, the control unit operates to cause the secondary electromagnetic field generator to generate an electromagnetic field that is pulsating with characteristic time τ being indicative of travel time for a signal passing the predetermined distance R.

Generally, the primary and/or secondary electromagnetic field generators may be in the form of a coil of electrical conducting wire. Such coils are configured to generate magnetic fields in response to electrical currents passing therethrough. The use of coils is generally preferred to provide a directional and relatively strong magnetic field with a moderate current. One of the electromagnetic field generators, e.g. the primary electromagnetic field generator, may be a static/permanent magnet configured to induce a static magnetic field.

The primary and secondary electromagnetic field generators are preferably arranged and oriented along their corresponding polar axes. For example, in the case of two coils, or a coil and a magnet, the electromagnetic field generators are arranged along a central axis of at least one coil and the north-south axis of the permanent magnet (if used). This is to provide optimal interaction between the primary and secondary electromagnetic field generators and the corresponding electromagnetic fields.

As indicated above, a net force acting on the system approximately corresponds to a second temporal derivative of an electromagnetic field pulsating by the primary or secondary electromagnetic field generators. For example, where at least one of the electromagnetic field generators is in the form of an electrically conductive coil, the total force acting on the system may generally correspond to a second temporal derivative of an electrical current transmitted through the coil, thereby causing generation of the electromagnetic field.

According to some embodiments, the control unit, and/or a switch mechanism therein, may be configured to provide the coil (either primary or secondary) with pulsating electric current in a form

$${I}_{2} ( t ) = 1 / 2 \overline{{I}_{2}} \frac{{t}^{2}}{{τ}_{c}^{2}} ,$$

where τ_{c} is a predetermined characteristic time scale chosen to be as short as possible to maximize the total force affecting the system. To obtain a significant force typically τ_{c} is selected to be shorter than the delay time determined by the distance between the primary and secondary magnetic field generators. Additionally I̅₂̅ is a predetermined typical current. It should be noted that, as such, a current profile is limited by a certain maximal output current that can be provided by a power source, and the control unit may be configured to provide pulsating current in a periodic form where each of the pulses has an appropriate current profile to provide a desired value of the second temporal derivative. It should be noted that one of the primary and secondary electromagnetic generators may be configured to create a pulsating electromagnetic field while the other one creates a constant magnetic field. Alternatively, both the primary and secondary electromagnetic field generators may be operated to create pulsating electromagnetic fields.

Thus, in one preferred application of this invention, the “primary” current remains constant (as in a permanent magnet), while the “secondary” current is pulsated on and off at intervals that may vary in short durations such as nano-seconds to pico-seconds and beyond, depending on the geometrical parameters of the “Primary-Secondary” system.

In light of the mathematical analysis performed, this invention teaches that the magnitude of the non-reacted force Fₚ is proportional to the square of r, and directly proportional to N₁N₂ and I₁I₂, where N₁, N₂ and I₁, I₂ are the respective number of turns and current units in the “primary” and “secondary” coils.

Thus according to a broad aspect of the present invention, there is provided a propulsion system comprising: primary and a secondary electromagnetic field generators attached to a rigid frame at a predetermined distance between them, and a switch connected to the secondary magnetic field generator and configured to create pulsating electromagnetic fields generated by the secondary magnetic field generator being pulsated at time intervals determined in accordance with retardation time determined by said predetermined distance between the primary and secondary electromagnetic field generators thereby providing a non-null force acting on the system.

According to some embodiments of the invention the secondary electromagnetic field generator is in the form of a coil, said switch being configured to provide the coil with pulsating electric current of a form

$${I}_{2} ( t ) = 1 / 2 \overline{{I}_{2}} \frac{{t}^{2}}{{τ}_{c}^{2}} ,$$

τ_{c} being a predetermined time scale, selected to be as a short as possible (and as technology allows). It should be noted that in order to provide a significant force acting on the system, τ_{c} is selected to be at least as short as the retardation time R/c determined in accordance with said predetermined distance between the primary and secondary magnetic field generators. Finally, I̅₂̅ is a predetermined typical current.

This is while the primary electromagnetic generator may be configured as a coil and operated to generate pulsating electromagnetic fields or a constant magnetic field. Alternatively the primary electromagnetic field generator may be a permanent magnet.

The switch of the system may comprise a MOSFET triggered micro-spark configured to provide electrical pulses of at least 6 kV being shorter than 10 nanoseconds. According to some other embodiments, the switch may comprise a micro-spark-semiconductor switch system configured to provide electrical pulses of at least 2.6 kV being shorter than 10 nanoseconds.

According to one other broad aspect, the present invention provides a method for generating closed-system propulsion (ignoring field momentum). The method comprises providing primary and secondary electromagnetic field generators fitted in a rigid frame at a predetermined distance between them, and switching electric current through the secondary electromagnetic generator to thereby cause the secondary electromagnetic field generator to create pulsating magnetic field at short time intervals determined in accordance with retardation time determined by said predetermined distance between the primary and secondary electromagnetic field generators thereby providing a non-null force acting on the system.

According to some embodiments, switching electric current through the secondary electromagnetic generator may comprise providing the secondary electromagnetic field generator with pulsating electric current of a form

$${I}_{2} ( t ) = 1 / 2 \overline{{I}_{2}} \frac{{t}^{2}}{{τ}_{c}^{2}}$$

where τ_{c} is a time scale determined in accordance with said predetermined distance between the primary and secondary magnetic field generators and I̅₂̅ is a predetermined typical current. It should be noted that the primary electromagnetic generator may or may not be operated to create pulsating electromagnetic fields.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 represents the generation of an Electro-Magnetic Field (EMF) by an electric charge (electron) moving along a coiled conductor and its Permanent Magnet equivalent;

FIG. 2 represents two electromagnetic coils located at a distance from each other;

FIG. 3 shows the asymmetric force generated under the teachings of this invention by the interaction of a Primary-Secondary System;

FIG. 4 shows the asymmetric force generated by the interaction of a Permanent Magnet Field with a Secondary Coil that creates the time delay “τ” effect by pulsating its field as by the teachings of this invention;

FIG. 5 shows the interacting currents flowing in different coil shapes used as by the teachings of this invention; and

FIG. 6 illustrates a propulsion system according to the present invention.

### DETAILED DESCRIPTION OF EMBODIMENTS

The present invention provides a novel technique and propulsion system configured to generate a directional force within a closed system environment. The following are examples of two embodiments thereof. This invention has two embodiment options:
1. A “primary” coil disposed in the proximity of a “secondary” coils system that may comprise one or more coils.
2. A permanent magnet that would replace the “primary” coil, disposed in the proximity of a “secondary” coils system comprising one or more coils.

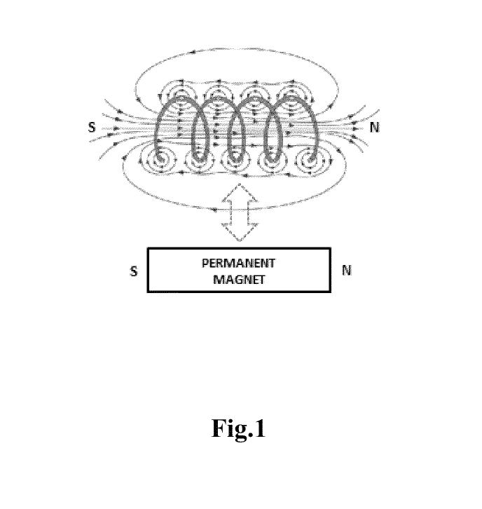

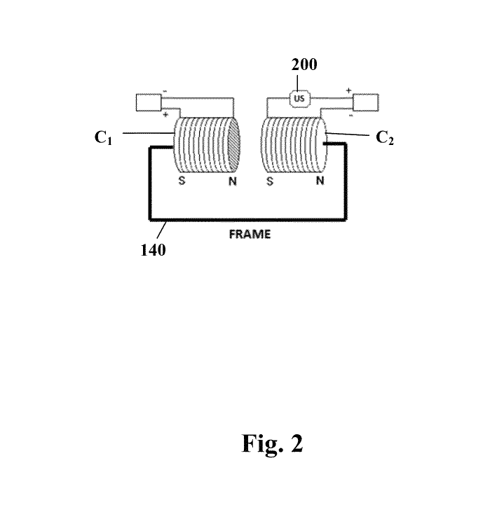

The first embodiment is represented by FIG. 2 where coils C₁ and C₂ are fitted in a frame 140, whereby C₁ generates a permanent electromagnetic field as shown in FIG. 1, while C₂ is pulsating its field by means of the Ultrafast Switch US. Generally, the ultrafast switch may be a part of a control unit 200 which is connectable to one or more of the electromagnetic field generators, and configured to cause the electromagnetic field generators to create appropriate electromagnetic fields as will be described further below.

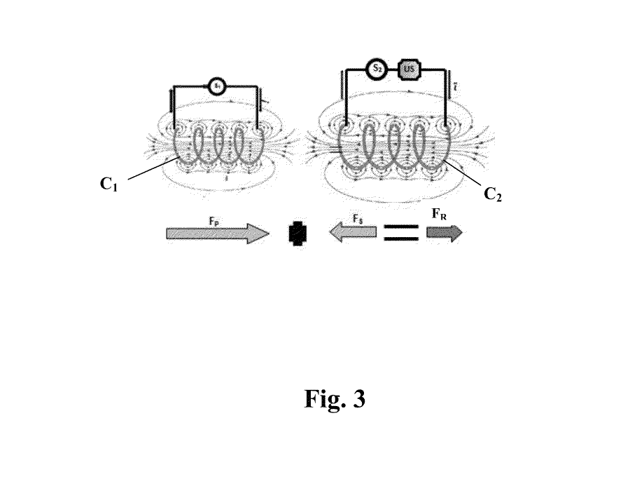

The Ultrafast Pulsation of the electromagnetic field generated by coil C₂ creates conditions similar to those developed by a system of remotely located Primary and Secondary coils wherefrom the time necessary for the electromagnetic field produced by Primary coil C₁ to interact with that of Secondary coil C₂ would have been long enough to provide for an asymmetric system of forces as depicted in FIG. 3 where S₁ is the primary power source, S₂ is the secondary power source, Fₚ is the electromagnetic force produced by Primary coil C₁, F_{S} is the electromagnetic source produced by Secondary coil C₂, and F_{R}≠0 is the resultant force occurring over delayed-time τ.

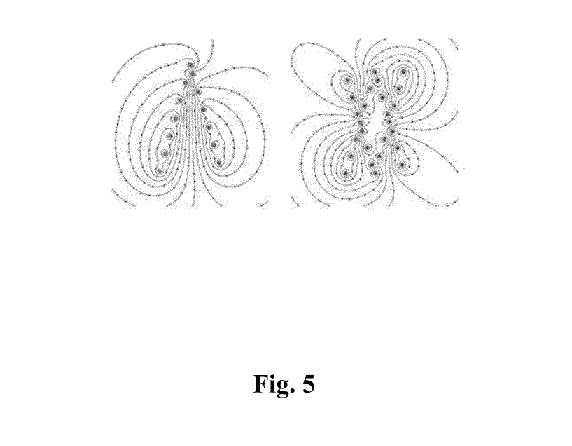

The Primary and Secondary coils may have any suitable geometry as exemplified in FIG. 5, without adversely affecting the attributes of this invention as above described.

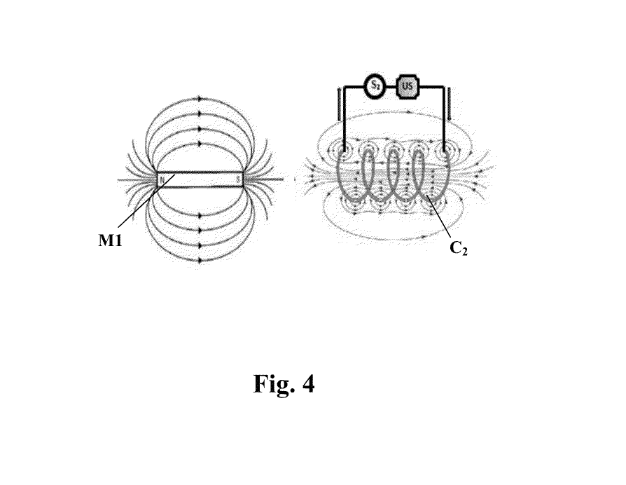

The second embodiment that replaced primary coil C₁ with a permanent magnet M1 as shown in FIG. 4, achieves the interaction of the permanent field of a magnet with that of a secondary coil which carries a suitable magnitude current of the second derivative of that which would have had created the magnet's field in a given coil. The secondary coil is pulsated for generating a time dependent electromagnetic field. The symbols of FIG. 3 were conserved in FIG. 4.

As indicated above, and will be described in more detail further below, the propulsion system of the present invention may generally be associated with a control unit including an ultrafast switching utility and configured to provide pulsating electric current to the secondary electromagnetic field generator (or generally to at least one of the field generators). The ultrafast switching utility is configured to actuate proper electrical current to thereby provide the desired total force acting on the system.

Ultrafast Switches (US) are commercially available as nanosecond pulse generators. Such US which provide kilo Ampere pulses, are required for applications with pulsed lasers, electro-optical devices, electron heating of plasmas, and bio-electrics, and include high-pressure spark gaps, photoconductive switches, and semiconductor opening switches. Most of the pulse generators based on these switch technologies are designed for high voltage, high power applications and are eminently suitable for the teachings of this invention.

Two US concepts were explored for the purposes of this invention:
1. MOSFET triggered micro-spark Marx-Bank, and
2. A combined micro-spark-semiconductor switch-system that includes simple, inexpensive nanosecond pulse generators.

The above compact pulse generators allow for electrical pulses of less than 10 ns at amplitudes of several kV. The Mini Marx Bank has been shown to provide 6 kV pulses of 6 ns duration into a 10 MΩ load and 2 kV into a 50Ω load. The “micro-spark switch” that uses a commercially available diode to shorten the pulse can provide 2.6 kV of 2 ns duration into a 50Ω load.

The low cost and compactness of the very simple Mini Marx-Bank generator makes this device appropriate for nanosecond pulsed-power devices.

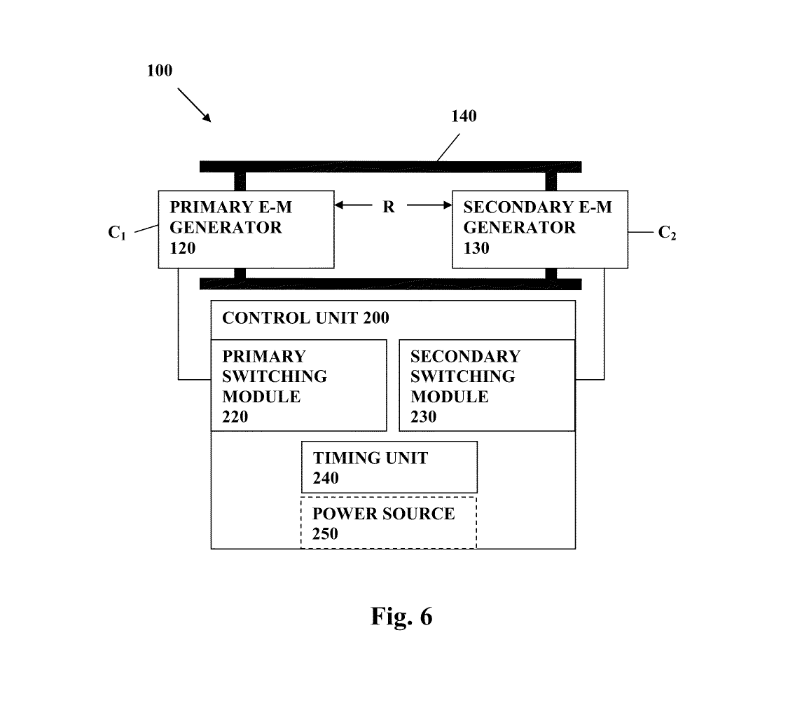

Reference is made to FIG. 6 illustrating a configuration of a propulsion system 100 according to the present invention. As noted above, the system 100 includes primary 120 and secondary 130 electromagnetic field generators both attached to a frame 140 at a predetermined distance R between them. The primary and secondary electromagnetic field generators 120 and 130 are connectable to a control unit 200 configured to operate at least one of the electromagnetic field generators to create a pulsating electromagnetic field to thereby generate a total net force acting on the system.

In order to enhance understanding the following description is based on some embodiments of the invention where the primary and secondary electromagnetic field generator 120 and 130 are configured as primary and secondary coils of electrically conducting wires C₁ and C₂. The two coils are attached to the frame 140 such that central axes thereof coincide, e.g. to define the z axis. It should however be noted that different arrangement of the primary and secondary electromagnetic field generators may also be used, and that the total net force is determined in accordance with electromagnetic interaction therebetween.

Generally, the force acting on one of the electromagnetic field generators due to the electromagnetic field created by the other electromagnetic field generators can be calculated by:

$${{F}^{->}}_{21} = \frac{{μ}_{o}}{4 π} {I}_{2} ( t ) ∮ d {{l}^{->}}_{2} \times ∮ \frac{{R}^{->}}{{R}^{2}} \times d {{l}^{->}}_{1} ( {I}_{1} ( {t}_{ret} ) + ( \frac{R}{c} ) {\partial }_{t} {I}_{1} ( {t}_{ret} ) ) \qquad ( equation 1 )$$

where μ₀ is the vacuum permeability, I₁(t) and I₂(t) are the electric currents passing through the primary and secondary electromagnetic generators respectively, R is the distance between the electromagnetic generators, c is the speed of propagation of electromagnetic fields (speed of light) and tᵣₑₜ is the retardation time, i.e. tᵣₑₜ=t−R/c. Additionally 1₁ and 1₂ are respective integration loops corresponding to the primary and secondary electromagnetic generators.

To identify the effects of interaction between the primary and secondary electromagnetic generators, the electric current I₁ is expanded by a Taylor series in R/c to provide:

$${I}_{1} ( {t}_{ret} ) = {I}_{1} ( t - \frac{R}{c} ) = {\sum }_{n = 0}^{∞} \frac{{I}_{1}^{( n )} ( t )}{ni} {( - \frac{R}{c} )}^{n} \qquad ( equation 2 )$$

where I₁⁽ⁿ⁾(t) is the n'th temporal derivative of I₁(t). Utilizing the Taylor expansion the force between the electromagnetic field generators is:

$${{F}^{->}}_{21} = \frac{{μ}_{o}}{4 π} {I}_{2} ( t ) {\sum }_{n = 0}^{∞} \frac{{I}_{1}^{( n )} ( t )}{ni} {( - \frac{1}{c} )}^{n} ∮ ∮ {∇}_{{x}_{2}} {R}^{n - 1} d {{l}^{->}}_{2} \cdot d {{l}^{->}}_{1} \qquad ( equation 3 )$$

here, x₂ defines the coordinates along l₂. However, ∇ₓ_{_{z}}Rⁿ⁻¹=(1−n)Rⁿ⁻³\vec{R} and this results in vanishing of the first order in R/c.

Utilizing a dimensionless geometrical factor \vec{K}₁₂ₙ and defining h as characteristic distance between the electromagnetic field generators:

$${{K}^{->}}_{21 n} = \frac{1}{{h}^{n}} ∮ ∮ {R}^{n - 3} {R}^{->} d {{l}^{->}}_{2} \cdot d {{l}^{->}}_{1} = - {{K}^{->}}_{21 n}$$

provides formulation of the total force acting on the system due to the electromagnetic field interaction with the electromagnetic field generators using the second order of the Taylor expansion (second order in R/c):

$${F}_{Total} = {{F}^{->}}_{21} + {{F}^{->}}_{12} = - \frac{{μ}_{0}}{8 π} {( \frac{h}{c} )}^{2} {{K}^{->}}_{122} [ {I}_{1} ( t ) {I}_{2}^{( 2 )} ( t ) - {I}_{2} ( t ) {I}_{1}^{( 2 )} ( t ) ] \qquad ( equation 4 )$$

As indicated above, according to some preferred embodiments, the primary and secondary electromagnetic field generators may be configured as multi-turns electrically conducting coils arranged along a common central axis thereof to thereby provide efficient interaction. Utilizing such geometry of the system, the dimensionless geometrical factor \vec{K}₁₂ₙ defined above corresponds to a product of the number of turns in each of the electromagnetic field generators, i.e. \vec{K}₁₂ₙ˜N₁N₂.

Thus the present invention provides a novel propulsion system utilizing relativistic effects on interaction of electromagnetic field generators located at a predetermined distance between them and attached to a frame. As noted, the total force acting on the system corresponds to a second derivative of the field generated by at least one of the electromagnetic field generators. According to some embodiments, the primary electromagnetic generator is operated to provide a constant magnetic field, e.g. by constant current I̅₁̅, while the secondary electromagnetic generator is operated by a pulsating current including repeating pulses of the form

$${I}_{2} ( t ) = 1 / 2 \overline{{I}_{2}} \frac{{t}^{2}}{{τ}_{c}^{2}}$$

thereby providing a total force acting on the system to be:

$${F}_{{Total}_{z}} ≅ 4.94 \frac{{μ}_{o}}{8 π} {N}_{1} {{N}_{2} ( \frac{h}{c} )}^{2} \frac{1}{{τ}_{c}^{2}} \overline{{I}_{1}} \overline{{I}_{2}} \qquad ( equation 5 )$$

operating along the z axis, being the common central axis defined above.

It should be noted that the propulsion system responds to such varying current by generating the total force of equation 5 during time periods where the second derivative of the current (generally of the created electromagnetic field) is not zero and provides an appropriate value. As currently available power source units are generally limited by their output current, the control unit generally operates the primary and secondary electromagnetic field generators by pulsating currents thereby providing bursts of total force in between short rest periods of the system. Such rest periods may be as short as relaxation time of the associated power source or control unit and may be of less than 1 ns.

Those skilled in the art will readily appreciate that various modifications and changes can be applied to the embodiments of the invention as hereinbefore described without departing from its scope defined in and by the appended claims.

1. A propulsion system comprising: primary and secondary electromagnetic field generators attached to a frame at a predetermined distance between them, and a control unit connectable to at least one of the primary and secondary magnetic field generators, the control unit being configured to cause the at least one of the electromagnetic field generators to create pulsating electromagnetic fields generated being pulsated at time intervals determined in accordance with retardation time determined by said predetermined distance between the primary and secondary electromagnetic field generators thereby providing a non-null force acting on the system.

2. The propulsion system of claim 1, wherein the secondary electromagnetic field generator is in the form of a coil, said control unit being configured to provide the coil with pulsating electric current of a form
$${I}_{2} ( t ) = 1 / 2 \overline{{I}_{2}} \frac{{t}^{2}}{{τ}_{c}^{2}} , {τ}_{c}$$
being a predetermined time scale determined in accordance with said predetermined distance between the primary and secondary magnetic field generators and I̅₂̅ being a predetermined typical current.

3. The propulsion system of claim 1, wherein the primary electromagnetic generator is configured to generate pulsating electromagnetic fields.

4. The propulsion system of claim 1, wherein the primary electromagnetic field generator is a coil providing a constant magnetic field.

5. The propulsion system of claim 1, wherein the primary electromagnetic field generator is a permanent magnet.

6. The propulsion system of claim 1, wherein the control unit comprises a MOSFET triggered micro-spark configured to provide electrical pulses of at least 6 kV being shorter than 10 nanoseconds.

7. The propulsion system of claim 1, wherein the control unit comprises a micro-spark-semiconductor switch system configured to provide electrical pulses of at least 2.6 kV being shorter than 10 nanoseconds.

8. A method for generating a closed-system propulsion, the method comprising providing primary and secondary electromagnetic field generators fitted in a frame at a predetermined distance between them, and switching electric current through the secondary electromagnetic generator to thereby cause the secondary electromagnetic field generator to create a pulsating magnetic field at time intervals determined in accordance with retardation time determined by said predetermined distance between the primary and secondary electromagnetic field generators thereby providing a non-null force acting on the system.

9. The method of claim 8, wherein switching electric current through the secondary electromagnetic generator comprises providing the secondary electromagnetic field generator with pulsating electric current of a form
$${I}_{2} ( t ) = 1 / 2 \overline{{I}_{2}} \frac{{t}^{2}}{{τ}_{c}^{2}} ,$$
τ_{c} being a predetermined time scale determined in accordance with said predetermined distance between the primary and secondary magnetic field generators and I̅₂̅ being a predetermined typical current.

10. The method of claim 8, further comprising causing said primary electromagnetic generator to create pulsating electromagnetic fields.
